(19) United States
(12) Patent Application Publication
(10) Pub. No.: US 2016/0232569 A1
(43) Pub. Date: Aug. 11, 2016

(54) ONLINE ADVERTISEMENT COMPENSATION SYSTEM AND METHOD

(71) Applicants: Sergey Pankov, Gold River, CA (US); Alexey Pankov, Gold River, CA (US); Vadim Enikeev, Kazan (RU); Sergey Kharlamov, Kazan (RU)

(72) Inventors: Sergey Pankov, Gold River, CA (US); Alexey Pankov, Gold River, CA (US); Vadim Enikeev, Kazan (RU); Sergey Kharlamov, Kazan (RU)

(21) Appl. No.: 14/618,840

(22) Filed: Feb. 10, 2015

(51) Int. Cl. G06Q 30/02

(52) U.S. Cl. CPC G06Q 30/0256; G06Q 30/0277

(57) ABSTRACT

A system and method for online advertising are disclosed. In the disclosed system and method, a compensation component remits payment to end users predicated on their views or clicks of internet advertisements whereby a user may receive compensation for his or her attention to the advertisements. In one embodiment, when the system and method is implemented, a user receives points for his or her attention to the advertisement within a proprietary browser-based search engine. The system and method further converts the points into monetary compensation based on a compensation component thereby increasing the motivation for users to view and/or select an online advertisement. The system and method utilizes a compensation component that will complete payment to the user. Depending on the embodiment, the advertisement may be broadcast or distributed using cellular telephone, other mobile devices, the World Wide Web, or other web-enabled mediums.

### BACKGROUND OF INVENTION

This application generally relates to systems and methods for online advertisements. Online advertisements are typically used to promote goods and services to the user. Further, online advertisements may comprise banner advertisements at the top of a webpage or links to other web pages, images, video, text, etc. Moreover, online advertisements can be displayed on a webpage in a wide variety of formats, such as within a result set in response to a search query, embedded in a webpage, or a pop-up window, etc. Additionally, online advertisements displayed on a user of a client device—such as a laptop, smartphone, personal desktop computer, a tablet, etc.—may be “clicked on,” “viewed,” or “selected” and thereby redirecting a user to the advertiser's website providing information regarding the goods or services associated with the online advertisement.

More recently, dynamic online advertisements, for example, animated multimedia characters, have been used. These types of online advertisements, while more noticeable than the typical banner advertisements on webpages and websites, are often intrusive, distracting, and bothersome to users. In addition, there is no real indication that such dynamic advertisements are effective. Although such animated advertisements are often entertaining, they are often ineffective in conveying the advertiser's message. The problem of waning attention continues to grow because of advances in technology and changes in entertainment forms and habits.

Software applications such as advertisement and pop-up blockers, for example, Adblock, make it ever easier to block or remove advertisements displayed on websites and webpages. However, many websites depend on advertisement revenue to operate the website and maintain its functionality and robustness. Furthermore, users also have the ability to ignore the advertisements by scrolling through the web page to make all or a portion of the advertisement disappear. As such, these types of advertisements are ineffective, and the efficacy of such advertising is questionable. As a result, a need exists for a more effective form of advertising. In response, marketers continue to try to find new ways to capture consumer attention on the Internet and various platforms. However, advertising on the Internet, and in other new forms of media, is still emerging, for example, Social Networking Platforms (hereinafter “SNP” or “SNPs”) like Facebook, Twitter, MySpace, Google, and Instagram all incorporate advertisement platforms to monetize their respective websites.

Click-through-rate (hereinafter “CTR” or “CTRs”) is an important parameter for online advertising, and is one of the more frequently used measures of the success of an online advertising campaign. A CTR provides a measure of online advertisement effectiveness in terms of user response to the advertisement. The purpose of a CTR is to measure the ratio of clicks to impressions of an online advertisement or marketing campaign. Generally, the higher the CTR the more effective the marketing campaign has been at bringing users or consumers to a website. Most commercial websites are designed to elicit some sort of action, whether it is to buy a book, read a news article, watch a music video, or search for a flight, etc. Users and consumers generally don't visit a website with the intention of viewing advertisements, just as people rarely watch TV with the purpose of viewing commercials.

The CTR of an advertisement is defined as the number of clicks on an advertisement divided by the number of times the advertisement is shown (impressions), expressed as a percentage. For example, if a banner advertisement is delivered 100 times (100 impressions) and receives one click, then the click-through rate for the advertisement would be 1%.

$$CTR = \frac{Clicks}{Impressions} \times 100$$

A high CTR is a good indication that users find particular online advertisements helpful and relevant. Online advertisements are omnipresent with respect to the Internet. Accordingly, marketers require an improved method and system for motivating a user or consumer to select, click, or view their respective online advertisements and thereby increasing the CTR and success of their marketing campaign. As websites depend on advertisement revenue to operate the website and maintain its functionality, robustness, and interoperability, there exists an impetus for users to select, click, or view the advertisement to increase market exposure for advertising campaigns and indirectly benefitting the websites which display such advertisements. The present invention addresses the foregoing issue.

### Summary

The present invention pertains to a system and method for online advertising. The system and method comprises a compensation component wherein a user is compensated for “clicking,” “selecting,” or “viewing” an online advertisement—depending on the format of the online advertisement—within a proprietary browser-based user interface, thereby acquiring points such that the points earned by a user are converted to monetary incentives in accordance with one or more decision rules or algorithms. For each user who clicks, selects, or views an online advertisement, the system and method further comprises confirming and validating that the user has clicked, selected, or viewed the online advertisement, in accordance with the system's protocols, and thereafter, providing the user with points to be subsequently converted into monetary compensation.

### BRIEF DESCRIPTION OF THE DRAWINGS

The drawings, when considered in connection with the following description, are presented for the purpose of facilitating an understanding of the subject matter sought to be protected.

FIG. 1 is a schematic illustrating the system according to one embodiment of the present invention;

FIGS. 2-5 are screens of various user interfaces according to one embodiment of the present invention;

FIG. 6 is a user interface according to another embodiment of the present invention; and,

FIG. 7. is an illustration of a track bar drag option component wherein a user can filter the manner in which advertisements are displayed.

### DETAILED DESCRIPTION

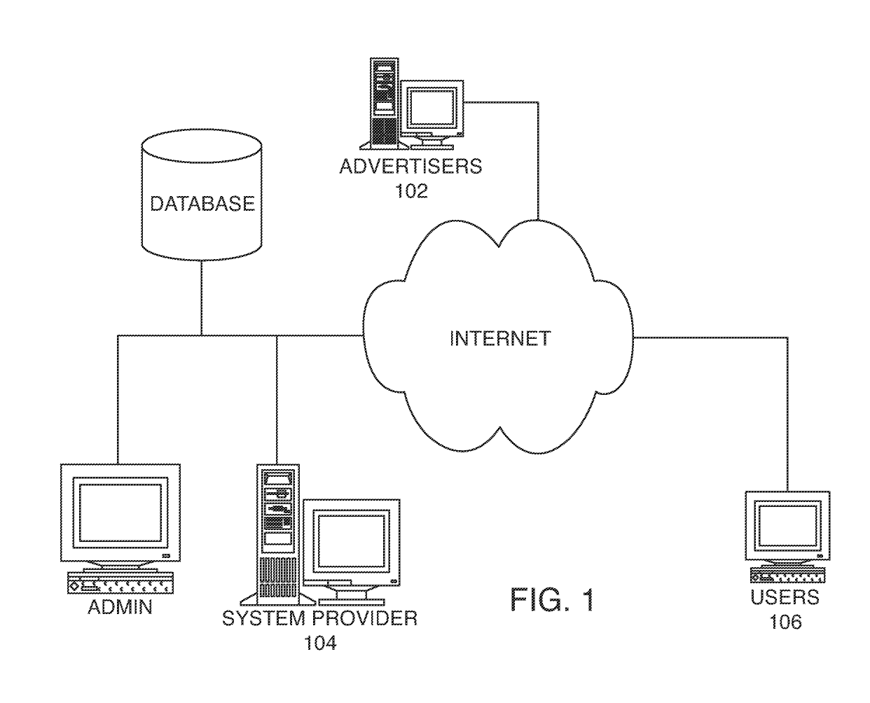

Certain embodiments of the present invention will now be described in greater detail with reference to the aforementioned figures. In general, the embodiment illustrated in FIG. 1 allows advertisers 102 to provide advertisements to a system provider 104, which in turn, provides users 106 with access to such advertisements. Moreover, as described in greater detail below, the system provider 104 comprises a compensation component that compensates users 106, by providing points to users 106 for each “click,” “selection,” or “view” of an online advertisement—depending on the format of the online advertisement. In addition, in the present embodiment, the compensation component converts the points accumulated by the users 106 to a monetary value by a set of decision rules, greater explained below.

In the present embodiment, the system provider 104 tracks how many advertisements the users 106 select, click, and/or view. Additionally, in the present embodiment, the system provider 104 provides monetary payments to the users 106 to select, click, and/or view online advertisements and the message therein by providing users 106 points for doing so. The act of users 106 selecting, clicking, and/or viewing an online advertisement will be collectively be referred to as “view” or “viewing” the advertisement hereinafter. The more advertisements the users 106 view, the more points the users 106 accumulate wherein the points are then converted to monetary values based on a set of decision rules.

As illustrated, the present embodiment involves advertisers 102, which have computer systems, such as one or more servers or personal computers, connected to a network, such as the Internet, for providing information, including the advertisements, to the system provider 104. The system provider 104 also has a computer system, such as one or more servers—for example, a web server, application server and media server—coupled to a database. As described in greater detail below, the database stores the information used in administering compensation to users 106 as well as how many advertisements the users 106 view, the number of points the users 106 have accumulated, the types of advertisements the users 106 tend to view, etc. The compensation component is configured to access the database for all information pertaining to user 106 payment information. The system provider 104 provides a website, with a user interface, through which the users 106 provide information to register or login. Thereafter, the users 106 can download an executable file to be installed on the users 106 client device, such that the executable is a browser-based search engine (which is not shown). Typically, users 106 upon logging into the system provider 104 will be directed to a browser-based search engine described in greater detail below. Subsequently, users 106 can input search requests through the browser-based search engine; retrieve a results set comprising one or more advertisements responsive to the search request and one or more advertisements unresponsive to the search request; accumulate points for selecting, clicking, or viewing said advertisements; and subsequently receive monetary compensation via a set of decision rules that convert the points acquired to monetary compensation. Thus, users 106 preferably include a computer, such as a personal computer, web-enabled smartphone, personal digital assistant, tablet, laptop, or the like.

Alternatively, in the same embodiment, after users 106 login or register with the system provider 104 and download/install the browser-based search engine, the users 106 can utilize the navigation bar to input a web address through said browser-based search engine. However, it should be noted that users 106 may utilize the browser-based search engine by first registering with the system provider 104 and then logging into said system provider 104. To this end, users 106, have the option to install the browser on their client device or utilize the system provider's 104 browser-based search engine depending on the embodiment. As such, users 106 can navigate to a website, e.g., YouTube.com, and within the browser-based search engine various advertisements will be displayed within the browser. In another illustrative example, users 106 can search for a term, or sequence of terms, utilizing the browser-based search engine and the result set will comprise advertiser listings and links related to the search terms. However, advertisements will be displayed within the browser that are both related to the search terms and unrelated to the search terms, as described in greater detail below.

Thereafter, the users 106 will accumulate points for viewing or selecting said advertisements, and subsequently, receive monetary compensation via a set of decision rules that convert the points acquired to monetary compensation.

In addition, users 106 can login or register with the system provider 104 through their Facebook, Instagram, Twitter, VK.com, and other SNP accounts that have been established and verified. In other words, the system provider 104 supports social login, also known as social sign-in, which is a form of single sign-on using existing login information from a social networking service such as Facebook, Twitter or Google+ to sign into a third party website in lieu of creating a new login account specifically for the system provider 104. It is designed to simplify logins for users 106 as well as provide more reliable demographic information to the system provider 104 and the advertisers 102. Social login is often considered a gateway to many of the recent trends in social software and social commerce because it can be used as a mechanism for both authentication and authorization. Social login links logins to one or more social networking services to a website, typically using either a plug-in or a widget. By selecting the desired social networking service, the user 106 simply uses his or her login for that service to login and/or register with the system provider 104. This, in turn, negates the need for the user 106 to remember login information for multiple electronic commerce and other websites while providing site owners with uniform demographic information as provided by the social networking service. Social login can be implemented strictly as an authentication system using standards such as OpenID or SAML. For consumer websites that offer social functionality to users, social login is often implemented using the OAuth standard. OAuth is a secure authorization protocol which is commonly used in conjunction with authentication to grant third party applications a “session token” allowing them to make API calls to providers on the user's behalf

As noted above, the system provider 104 includes a database for storing information utilized in the present embodiment. It is to be understood that such information may be stored in any of a number of ways, including one or more databases having one or more tables. Furthermore, the logical arrangement and relationship of such data and/or tables within a database may take any of a number of forms. Moreover, the system provider 104 will utilize the database in configuring which online advertisements a user 106 will be exposed to, for example, based on a user's prior search history, prior websites visited, age, demographic, location, socioeconomic status, the advertisers' 102 targeted audience, and other information stored in the database. As a result, the following is one exemplary structure of the database.

The database includes user tables which includes authorization information for each user 106, as identified by a unique user identifier (ID). To this end, each record in the table includes the user ID, the user's login ID and password, the user's social login information, the user's status (e.g., Enabled (in that the user's demographic and identification data has been entered correctly such as a valid telephone number and date of birth); Disabled (in that the user's data has not been entered correctly, and needs to be corrected by the user, or the user's account has been manually suspended for another reason); Verified (in that the user's demographic and identification data has been validated as accurate and truthful by a third-party verification service); and Unverified (in that the user has submitted registration information and the information is in the process of being validated for accuracy and truthfulness). Furthermore, each record in the user table also includes an indication of the last Internet Protocol address from which the user 106 accessed the system; the total number of user logins, and a record, updated in real time, of which online advertisements the users 106 selected, clicked, and/or viewed; the total number of points the users 106 accumulated; the monetary value of the points; and the compensation to be remitted to the users 106 based on the monetary values. As with the other tables, each record preferably includes the date and time the record was created, and the date and time the user profile was last modified.

Additional user identifying information is contained in the user tables, which for each user ID, contains the user's first and last name, driver's license number, social security number, address, e-mail, phone number(s), credit card information (name, number, expiration date, etc.), user's billing address, bank account information, and the dates the record was created and last modified. In the present embodiment, the telephone number is used primarily to verify the user's identity and, therefore, may be replaced or augmented by driver's license information or the like. Furthermore, the bank account information is used primarily to transfer payment to the user via wire transfer, direct deposit methods, or the like.

In the present embodiment, the users 106 are provided with cash incentives for viewing online advertisements. The cash incentives are distributed by the system provider 104 as advertisers 102 compensate the system provider 104 by a multitude of fee structures. For example, one fee structure comprises the advertisers 102 purchasing advertising space from the system provider 104, such as paying for the displaying of their advertisement as banner advertisements—which delivers the advertiser's message along the horizontal top edge of the browser-based search engine provided by the system provider 104. Alternatively, the advertisers 102 may pay the system provider 104 for displaying their advertisement as skyscraper advertisements, which deliver the advertiser's message along a vertical edge of a web page—or in this case the vertical edge of the browser-based search engine provided by the system provider 104. In other words, advertisers 102 can purchase advertising space within the browser-based search engine based on the positioning of one or more advertisements in response to a given search request provided by the users 106 or the user's 106 prior search history, prior websites visited, age, demographic, location, socioeconomic status, the advertisers' 102 targeted audience, and other information stored in the database.

In addition, advertisers 102 may compensate the system provider 104 based on the number of clicks (selections) or views their advertisement receives, for example, the advertisers 102 will pay the system provider 104 a total of $0.35 per click per user with regards to their advertisement—the price per click will vary depending on the advertiser's 102 and system provider's 104 preferences. Or, advertisers 102 will pay the system provider 104 based on the increase of the CTR of their respective advertisement further based on a set of decision rules. While such monetary incentives may be provided to the users 106 in any of a number of ways, for example, by crediting the user's credit card account or bank account or simply issuing a check or other form of payment, the present invention may alternatively use a third party on-line payment service in which users of the service transfer money using the third party service as a conduit. One well-known service provider is PayPal, Inc., whose system is described on the PayPal site at the domain www.paypal.com.

In addition to including information on the individual users 106, the system provider 104 includes information concerning the advertisers 102 and the advertisements being served. For example, the database includes advertisement tables which store information concerning each advertisement. To this end, each record in the advertisement tables include, for each advertisement as identified by a unique advertisement ID, the name of the advertisement; the date on which the advertisement was selected by various users 106; the date on which the advertisement may no longer be provided to users 106; the manner in which the system provider 104 is compensated by the advertisers 102; the name of the advertiser; the brand being marketed in the advertisement; which users 106 have viewed the advertisement; how many users 106 select the advertisement per hour, per day, per week, per month, and the like. The advertisement tables also include a field specifying the path and file name of the advertisement, thereby allowing the system provider 104 to dynamically access and serve the advertisement to the users 106.

However, the system provider 104 prevents users 106 from exploiting the system, e.g., clicking the same online advertisements repeatedly; using programs, bots, or scripts to view the advertisements; one user 106 logging in from multiple Internet Protocol addresses at the same time, and other forms of fraud and exploitation, etc. The system provider 104 is also programmed to restrict the users 106 activity, such as limiting the duration and time periods of when the users 106 can earn points. Furthermore, the user's selection of each advertisement is monitored by the system provider 104 and tracked. The advertisements that are selected and viewed are stored in the advertisement tables, as noted above. To reiterate, each record identifies the advertisement ID, which uniquely identifies the advertisement, how many users 106 have viewed the advertisement, which users 106 have viewed the advertisement and the frequency and rate the advertisement is viewed by users 106 including the demographic, psychographic, and behavioral characteristics associated with the users 106 who have viewed the advertisements. It is to be appreciated that the information collected is to be made available to the advertisers 102, through a report, output file, export file, and the like, so the advertisers 102 can better tailor advertising campaigns and better design individual advertisements to increase attention from consumers and also increase CTRs.

Information concerning compensation to the user is stored in the user tables. Each record corresponds to a different advertisement (as identified by advertisement ID) and stores the amount of the cash incentive provided to the user 106 when viewing the respective online advertisements. Different advertisements may provide, distinguished by advertisement ID, different levels of monetary compensation to the user based on a set of decision rules by the system provider 104. For example, some advertisers 102 may compensate the system provider 104 with $1.00 per click per user, while other advertisements may provide the system provider 104 with $0.25 per click per user—the compensation value and requirements will vary according to the advertisement tables associated with each of the advertisers 102 preferences. In yet another example, some advertisers 102 may compensate the system provider 104 based on the position of their advertisements within the system provider's browser based search engine. These incentive levels will be specified and decided upon by the advertisers 102 based on their brand goals, number of users they want to reach, budget, etc.

To this end, the system provider 104 will utilize a set of decision rules or algorithms to distribute a percentage of advertising revenue to the user. For example, if the system provider 104 displays one thousand advertisements (1,000 impressions) that are to be clicked, selected, and/or viewed by ten users 106, then the algorithm may divide the number of advertisements displayed by the number of users.

1,000 impressions/10 users=100 points

As such, the algorithm may further decide that one hundred points is equivalent to $1.00 where each of the ten users receives $0.90 (or 90%) and the system provider 104 receives $0.10 (or 10%) with respect to the advertisement revenue generated. However, it is to be understood that the system provider 104 decides the formula and method of calculation related to the distribution of compensation to the users 106 based on its own analytics, and decision rules. Further, the method and system of compensation will always utilize a tabulation of points acquired per user. The conversion of points to monetary compensation may be performed daily, weekly, monthly, etc. as decided by the system provider 104 by various algorithms and decision rules.

The database further tracks the amount of the user's monetary compensation to date, including past earnings as well as the average daily, weekly, and monthly earnings a user acquires by viewing the online advertisements. To this end, the database includes user compensation tables. The user compensation tables include one or more record for each user, as identified by user ID. More specifically, each record pertaining to a particular user corresponds to an advertisement for which the user earned monetary compensation and stores the amount of the monetary compensation received by a user; the date and time the user requested payment; the date and time the system provider 104 issued payment; and the form of payment remitted by the system provider 104.

Similarly, the user compensation tables include a record for each user, as identified by user ID, that has requested all or a portion of the monetary compensation to be cashed out. As such, each record in the user compensation table includes the user ID, the amount requested, the date of the transaction, the transaction number, and an indication as to when the record was created and last modified.

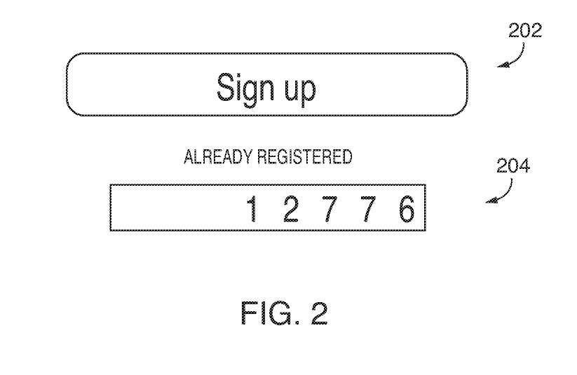

Having described the components of the present embodiment, its operation will now be described in greater detail with reference to FIGS. 2-5. It is to be understood that the functionality of the system described herein may be implemented in any of a number of ways, but is preferably provided via one or more software programs or components running on the system provider's computer system. Turning first to FIGS. 2-5, there is shown a series of user interfaces provided via the system provider 104. In operation, users 106 first access the system provider's web site at http://www.browserns.com. FIG. 2. Thereafter the users 106 must click the “sign up” button 202.

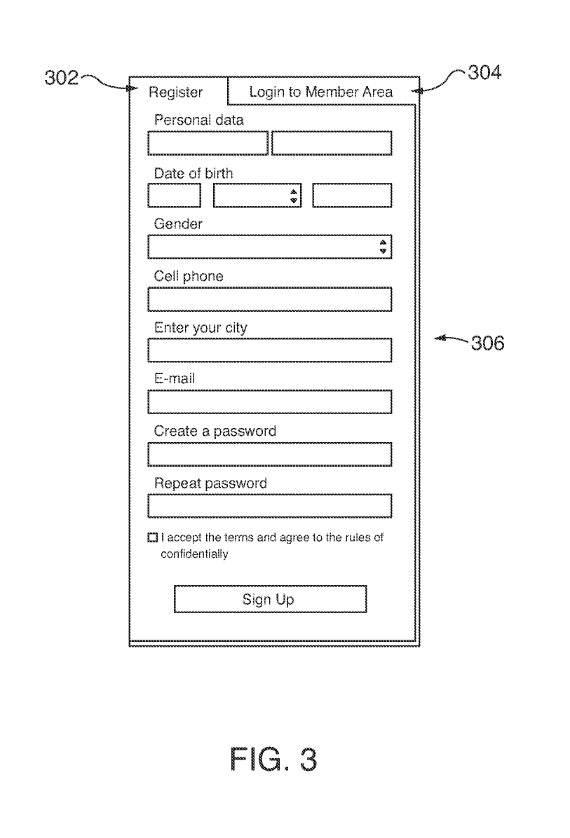

Referring to FIG. 3, having selected the “sign up” button 202 the users 106 are redirected to a webpage where the users can select a link to login 304 or register 302. Having selected the link to register 302, the users are presented with a registration form 306 of FIG. 3. As illustrated, the registration form includes fields for collecting the information used to create the user's record in the user tables and user compensation tables. A registration component is configured to store the users 106 information in the proper database tables and to verify the users 106 login information with the information stored in the database tables to ensure the login information is correct based on the user's database record. As also illustrated, some of the fields contain pull down menus for selecting one of multiple predefined answers. As part of the registration process, the system also assigns the user a user ID.

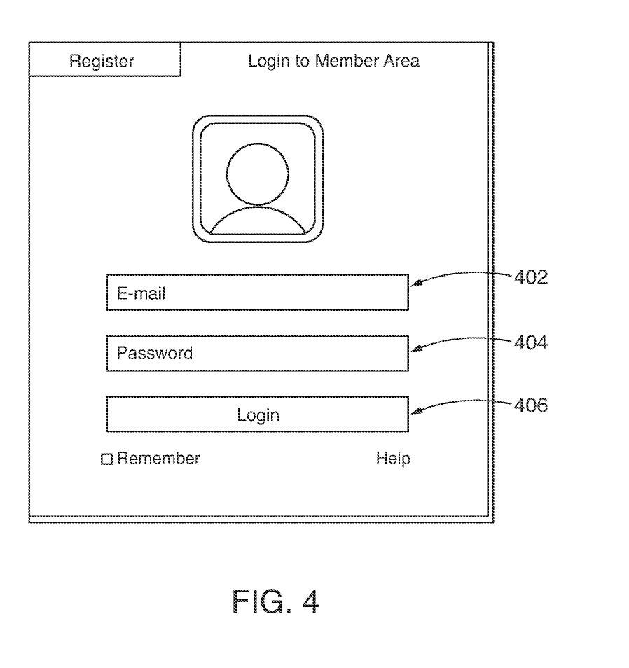

Users 106 who have already registered with the system provider 104, may select the login link 304. Having selected the login link 304, users 106 will be presented with the user interface in FIG. 4. The user 106 must input their email address 402 and password 404, then select the login button 406. As part of the login process, the system provider 104 confirms the email address and corresponding password exist in the database, and the system confirms the status in that the database indicates that the user 106 is enabled and verified.

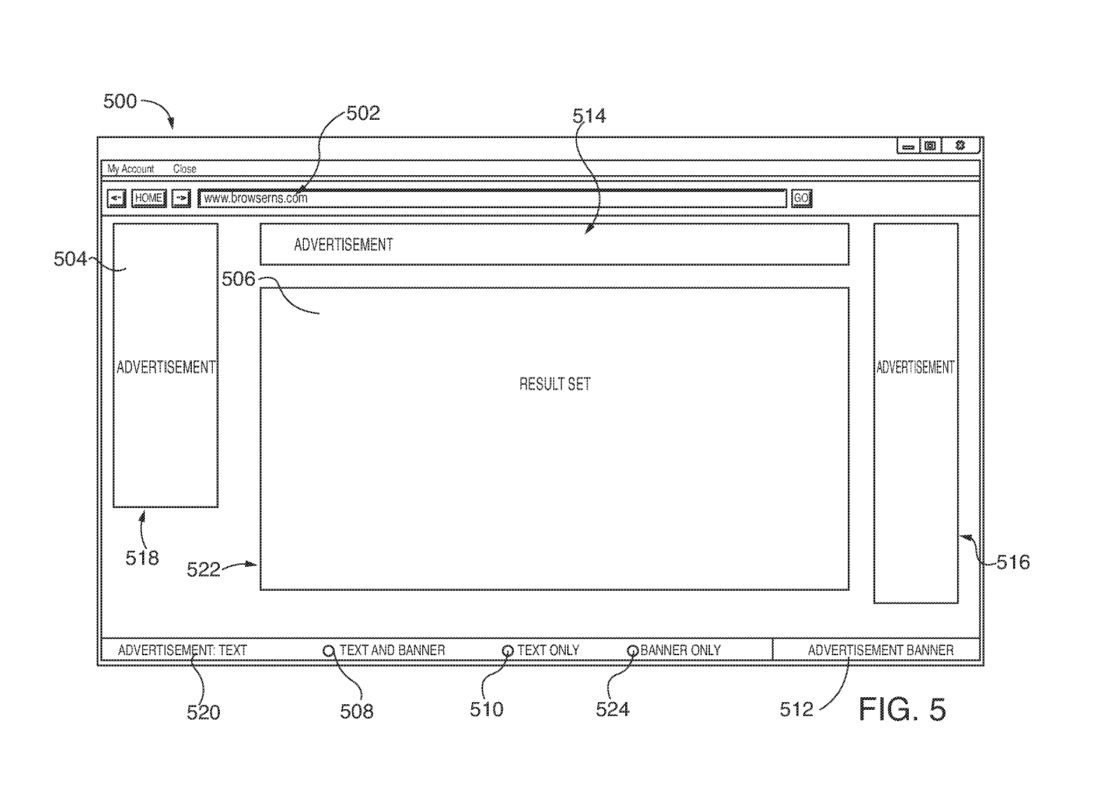

Once the user 106 is logged into the system provider 104, the user is presented with a browser-based search engine 500. FIG. 5. The browser-based search engine 500 will display an embedded navigation bar 502 wherein a website address or search query can be inputted—similar in functionality to Google.com, Bing.com, Ask.com, and the like. The browser-based search engine 500 may be designed and implemented using various programming languages and Application Programming Interfaces (API). The browser-based search engine 500 receives a search query from the users 106. Thereafter, the system provider 500 provides for transmission of the search queries, as well as receipt and display of a result set 522 which may comprise both specific web page listings and paid listings from advertisers based on relevancy to the user's 106 initial keyword search entry.

The result set 522 will also contain advertisements displayed on a page having the following information: the advertisements of those that the particular user 106 qualifies to view based on the result set 522, the total pool or set of advertisements that are available for the user to view based on the result set 522, and various advertisements placed within the browser-based search engine 500 by the system provider 104, such as in the form of banners 512, 514, 516, 518, 520, 524, and 526. When the user 106 activates (selects) the link for viewing an advertisement, the system provider 104 provides the user 106 with another page in which the advertisement is shown in greater detail or redirects the user 106 to the advertiser's 102 webpage associated with the advertisement. Further, the user 106 can select “my account” 504 from the toolbar (or menu bar) where the user 106 is then presented with its current hourly, daily, weekly, monthly, and aggregate total of points accumulated. Moreover, users 106 can select “exit” 506 from the toolbar to close the browser 500 and logout of the system provider 104.

Additionally, the browser-based search engine may include radio buttons (508, 510), checkboxes, speed buttons, track bar drag options, or bit buttons (which is an animated button). The form of the buttons will vary depending on various embodiments, the programming language used to implement the browser, and customization of the browser-based search engine 500 based on the users 106 preferences. The foregoing buttons 508, 510 (in their various forms), will enable, disable, and filter advertisements with respect to the manner the advertisements are displayed. Having selected radio button 508, in the present example, the button enables “text and banner” advertisements to be displayed. As such, the user 106 will be presented advertisements in their original format, e.g., full banner advertisement 514, half banner advertisement 512, flashing or animated advertisement (not shown), button advertisement 520, leaderboard advertisement (not shown), skyscraper advertisements 516 and 518, square box advertisement (not shown), square pop-up advertisement (not shown), half page advertisement (not shown), etc.

However, the user 106 can also select the “text only” 510 button or function depending on the embodiment, which enables the user to use specific choice of viewing online advertisements in a text-based format. It should be understood that the present invention covers all manners of displaying the advertisements to the users 106. In the present embodiment, the advertisements are streaming media served from the system provider's server; however, in alternate embodiments, the advertisement may be streamed from the advertiser's own server.

The system provider 104 updates both the list of available advertisements that the user 106 viewed within a predetermined amount of time (e.g., the same day, week, fourteen day period, month, and the like) and the points accumulated by the user for such activity. As such, advertisers 102 are assured that a single user 106 cannot repeatedly view the same advertisement thereby receiving points for viewing the same advertisement repeatedly.

When an advertisement is displayed, the system checks the database to determine the set of advertisements that the user has viewed for payment by comparing the advertisement tables to the user's record in the user tables. From this set of advertisements, the system excludes those advertisements identified as being previously viewed by the user 106 (as indicated by a record in the database having the advertisement ID). The last date and time the user 106 viewed the advertisement is indicated in the database. The difference between this date and time and the then current date and time is compared against a predefined time period (e.g., day, week, number of hours, number of days, and the like) to determine whether the user 106 can view the advertisement again.

Those skilled in the art will recognize that the method and system of the present invention has many applications, may be implemented in many manners and, as such, is not limited to the foregoing exemplary embodiments and examples. Moreover, the scope of the present invention covers conventionally known and future developments of the variations and modifications to the system components and processes described herein as would be understood by those skilled in the art.

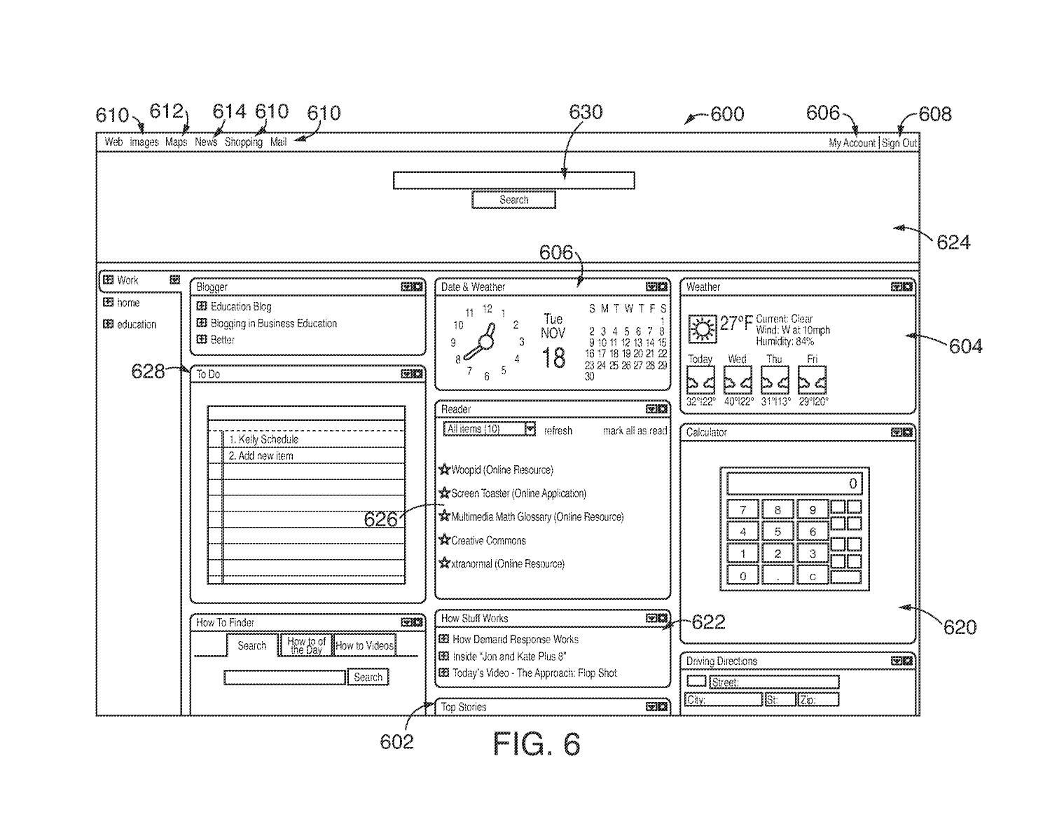

Referring now to FIG. 6, in another embodiment of the present invention, additional components of the browser-based search engine 600 are displayed. To this end, the browser-based search engine 600, preferably displays the following components (hereinafter components and widgets are used interchangeably) within the browser-based search engine 600: the five most recent news headlines in the browser 602; popular RSS news feeds (Rich Site Summary) 626; a weather component that displays the weather conditions and temperature based on the IP location of the user 604; a clock and calendar 606; a calculator 620, and a “to-do” list of tasks 628.

The browser-based search engine 600 will display a top toolbar with links to a “my account” page 606; a “sign out” link 608; a link to search images only 610; a link to search maps and directions 612; a link to news headlines 614; a link to search shopping websites 616; and a link to the user's email homepage 618. However, it is to be understood that additional components or widgets are available but not shown. Further, the browser-based search engine 600 will display a search bar 630; bookmarked and favorite websites 622; flash or other games (not shown), links to online streaming radio stations (not shown), and additional links.

When a user clicks the “my account” link 606 a user can manage their settings, profile, and points accumulated. In addition, the foregoing components can be dragged and placed in different locations within the browser-based search engine 600 based on the users' 106 preferences. Thus, the user has the ability to rearrange and customize the browser-based search engine 600 to personalize it. For example, the user may change the background image 624; the user may place the calendar 606 where the calculator 620 is and vice-versa by dragging the components/widgets. A user can drag all the components, including but not limited to, 602, 606, 604, 622, 620, 624, and 628 to different locations in the browser-based search engine 600 based on their preferences. For example, a user can move the weather 604 where the calendar and clock is 606, or vice-versa.

Furthermore, each user 106 is also presented with the option of withdrawing payment from the personal account page (not shown). To reduce administrative costs, however, the system preferably restricts each user 106 from withdrawing payment below a certain threshold. When a user 106 activates the withdraw button (not shown), the user is presented with another page asking the user to specify how much it wishes to withdraw and the manner in which the user 106 wishes to receive payment. In certain embodiments, the user is required to withdraw all of its funds and/or receive payment in a predetermined manner. A user's decision to withdraw payments causes a record to be created in the database.

Additionally, the browser-based search engine 500, will further display a news page with filtering aspects pursuant to locale news, national news, news presented in video format, news presented in photo format, which may depend on local data availability. However, if no local data is available, the browser-based search engine 500 will select and display current headlines based on a set of decision rules. Similarly, news will also be categorized and compartmentalized according to topic, such as, science, business, technology, etc.

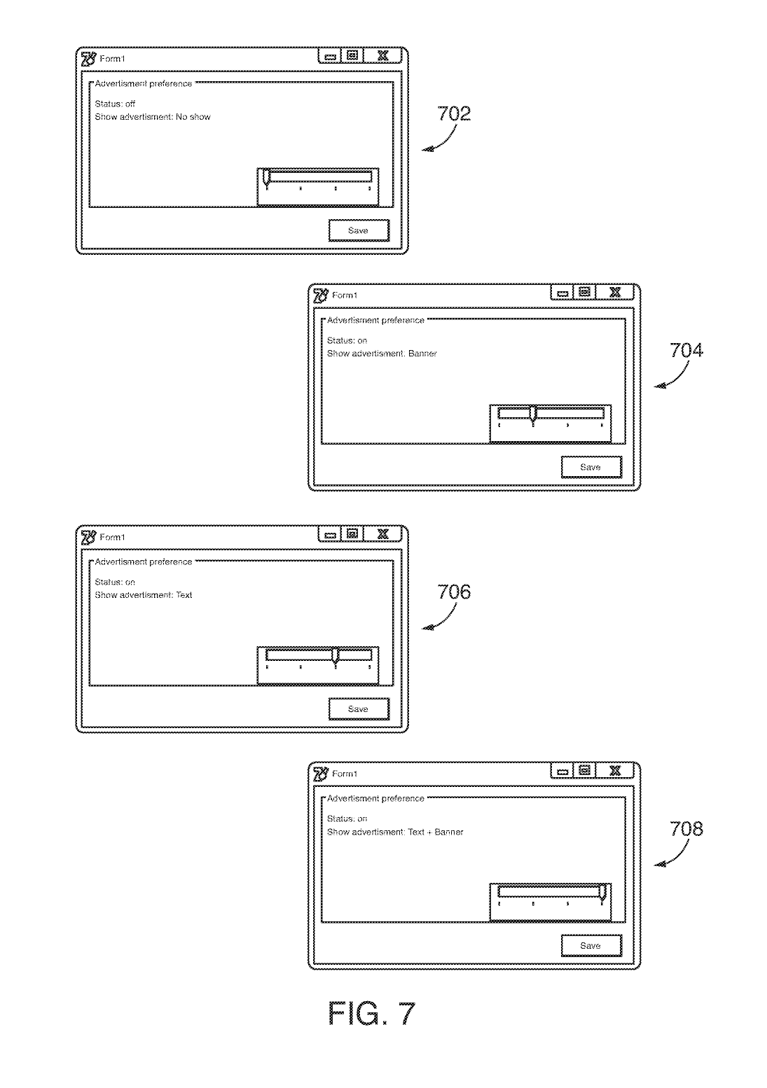

Referring now to FIG. 7, is an illustration of a track bar drag option component wherein the user can filter the manner advertisements are displayed to the user. The user can choose to turn off advertisements 702; view advertisements with respect to the banner only 704; view advertisements with respect to text only 706; and view advertisements with respect to both the text and banner of the respective advertisement 708. As such, it should be understood that this component (or function) may be implemented in many ways and may use other buttons, such as, radio buttons (508, 510), checkboxes, speed buttons, or bit buttons (which is an animated button). As noted above, the form of the buttons will vary depending on various embodiments, the programming language used to implement the browser, and the customization of the browser-based search engine 500 based on the users 106 preferences.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

It should be understood that the various examples of the systems and methods disclosed herein may include any of the components, features, and functionalities of any of the other examples of the systems and methods disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

What is claimed is:

1. A system for providing online advertisements within a browser-based search engine, the system comprising:
one or more participant terminals operable to act as a client on a network;
a browser-based search engine, wherein said browser-based search engine includes a registration component configured to register a user as a registered user in order to login to said browser-based search engine, wherein the registration component is adapted to store a registered user's login information in said database, and wherein the registration component is configured to verify the registered user's login information with said database, and wherein said registration component is adapted to access a user table corresponding to said registered user, wherein said user table corresponding to said registered user contains a user status, and wherein said registered user can access the browser-based search engine when said user status is enabled;
a computer operable to act as a server on the network and to communicate with each of the participant terminals over the network, the computer comprising:
a memory configured to store a set of instructions; and
a processor configured to execute the set of instructions, wherein the set of instructions cause the processor to:
receive a search term including one or more search terms from said registered user;
search the internet for each search term utilizing said browser-based search engine;
retrieve a result set, wherein said result set includes one or more instances where the one or more search terms have been utilized in the internet, and wherein said result set includes a list of paid listings from advertisers; and wherein said list of paid listings includes a list of links to a product from said advertisers, and wherein the client is adapted to display said result set in said browser-based search engine;
display said online advertisements, wherein said online advertisements include a portion that is responsive and a portion that is unresponsive to the search terms to the registered user through said browser-based search engine, wherein said online advertisements are configured to be displayed within said browser-based search engine, and wherein said online advertisements have a corresponding advertisement table in said database, and wherein said corresponding advertisement table contains a record, and wherein the record includes a unique advertisement ID, and wherein said online advertisements are further adapted to be displayed within said browser-based search engine in various forms, and wherein said browser-based search engine is adapted to display said online advertisements through the use of said client, and wherein the client is configured to display said online advertisements in said browser-based search engine through the internet;
calculate a point score based on a registered user's activity, wherein the point score is stored in said user table corresponding to said registered user, and wherein the system is configured to convert said point score to a monetary value by implementing an algorithm coupled to a compensation component; and,
compensate said registered users with said monetary value utilizing said compensation component, wherein said compensation component is configured to access said user table corresponding to said registered user to distribute the appropriate monetary value based on said point score of said registered user.

2. The system of claim 1, wherein said registered user's activity includes clicking the online advertisements.

3. The system of claim 1, wherein said registered user's activity includes viewing the online advertisements.

4. The system of claim 1, wherein said registered user's activity includes clicking and viewing the online advertisements.

5. The system of claim 1, wherein said various forms includes banners.

6. The system of claim 1, wherein said various forms includes animated advertisements.

7. The system of claim 1, wherein said various forms includes pop-up advertisements.

8. The system of claim 1, wherein said various forms includes button advertisements.

9. The system of claim 1, the processor in response to further executable instructions, further operative to:
distribute said monetary value to said registered user via a third-party payment system.

10. The system of claim 1, the processor in response to further executable instructions, further operative to:
stream media from an advertiser, wherein the advertiser has a server configured to transmit said online advertisements over the internet.

11. The system of claim 1, the processor in response to further executable instructions, further operative to:
stream media from an advertiser, wherein the system has a server configured to transmit said online advertisements over the internet.

12. The system of claim 1, wherein said user table corresponding to said registered user is configured to store said registered user's social login information, and wherein said social login information includes login information associated with at least one social networking service.

13. The system of claim 1, the processor in response to further executable instructions, further operative to:
receive an indication that said online advertisements has been clicked by said registered user within the browser-based search engine, wherein the indication is stored in said user table corresponding to said registered user and an advertisement table corresponding to each of the online advertisements in said database; and,
receive an indication that the advertisement has been viewed by the registered user within the browser-based search engine, wherein the indication is stored in a said user table corresponding to said registered user and an advertisement table corresponding to each of the online advertisements in said database.

14. The system of claim 1, the processor in response to further executable instructions, further operative to:
compile information based on the online advertisements that said registered user has viewed or selected, wherein said information is available to advertisers, and wherein said information is stored in said user table corresponding to said registered user and the advertisement table corresponding to each of the online advertisements in said database, and wherein said information can be exported to said advertisers; and,
store information based on demographic, psychographic, and behavioral characteristics associated with the registered user in the database.

15. The system of claim 1, the processor in response to further executable instructions, further operative to:
display the advertisements according to a registered user's preferences, wherein the registered user's preference comprises at least one of the following:
display said online advertisements with text only;
display said online advertisements with text coupled with said banner;
display said online advertisements with said banner only; and
display no online advertisements.

16. The system of claim 1, the processor device in response to further executable instructions, further operative to:
calculate a click-through-rate for said online advertisements;

17. The system of claim 1, wherein said compensation component is configured to receive compensation by advertisers based on at least one of the following:
calculating a number of clicks said online advertisements receive;
calculating a number of views said online advertisements receive;
calculating an increase in the click-through-rate for said online advertisements;
and,
displaying said online advertisements in said browser-based search engine.

18. The system of claim 1, the processing device in response to further executable instructions, further operative to:
display advertisements based on an advertiser's preference, wherein the advertiser's preference is stored in a corresponding advertisement table, and wherein the corresponding advertisement table includes demographic, psychographic, and behavioral characteristics of the registered user or a group of registered users.

19. The system of claim 1, wherein said online advertisements have an advertisement profile in the database, wherein the advertisement profile contains a corresponding unique advertisement ID, a name of said online advertisements, a date on which said online advertisements were selected by said registered users, a date on which said advertisements may no longer be provided to said registered users, a description of how the system is compensated for displaying said online advertisements, a name of an advertiser associated with said online advertisements, and a list of which registered users have viewed said advertisement.

20. The system of claim 1, wherein said database is configured to include user tables which includes authorization information for each registered user as identified by a unique user identifier, and wherein said user tables contain a record which includes a registered user's login and password, a registered user's social login information, a registered user's status, a registered user's first and last name, a registered user's driver's license number, a registered user's social security number, a registered user's address, a registered user's e-mail address, a registered user's phone number(s), a registered user's credit card information, a registered user's billing address, and a registered user's bank account information,
